(19) United States
(12) Patent Application Publication
(10) Pub. No.: US 2015/0058120 A1
(43) Pub. Date: Feb. 26, 2015

(54) Multiple Precision Ad Targeting

(71) Applicant: Hulu, LLC, Santa Monica, CA (US)

(72) Inventors: Dong Guo, Beijing (CN); Xuan Wei, Beijing (CN); Hua Zheng, Beijing (CN); Joyce Zhang, Beijing (CN)

(73) Assignee: Hulu, LLC, Santa Monica, CA (US)

(21) Appl. No.: 13/974,982

(22) Filed: Aug. 23, 2013

(51) Int. Cl. G06Q 30/02

(52) U.S. Cl. CPC G06Q 30/0254
USPC 705/14.52

(57) ABSTRACT

In one embodiment, a method determines advertisement (ad) impressions previously determined for a site and respective predicted probabilities determined for the ad impressions. A mapping table is generated mapping predicted probabilities to respective precisions using seed data associated with the ad impressions. The method generates optimal options for using the first level and the second level for the segment using the mapping table. The optimal options include a first precision for the first level, a second precision for the second level, and a ratio of ad inventories allocated to the first level and the second level. Then the method selects one of the optimal options. The selected one of the optimal options includes parameters including a first threshold for the first level, a second threshold for the second level, and the ratio that are used to test whether a predicted probability for an ad impression is targeted to the first level or the second level.

### BACKGROUND

Advertising-supported distribution of audio-video data may be implemented from a content server to remote client devices over computer networks, telecommunications networks, and combinations of such networks, using various methods, such as progressive downloading or streaming. Platforms for such distribution may include sites that offer a great variety of different programming, including both newly released episodes of serial programs, major features, documentaries, special events, archives of past episodes and classic serial programs, targeted to users having various different demographic profiles. One or more video ads may be inserted into each video program and sold to advertisers who are charged based on how many times each advertisement is played on a client device; i.e., for each video ad impression.

Ad targeting attempts to deliver an advertiser's ad to the preferred audiences. In one example, a site may offer guaranteed ad targeting. When an advertiser purchases a video ad with guaranteed ad targeting, the advertiser is only charged when an ad impression to a targeted audience is determined to occur. For example, the advertiser may specify that the advertisement must be viewed by a female viewer between the ages of 18 and 34. The site attempts to only deliver the ad to the users that are female between the ages of 18 and 34. Usually, the site knows the profile of registered users by the information they provided during registration. However, the site may not know the gender, age, and other profile of anonymous users. Most of the time, the site can calculate the probability that the ad impression is from a female between ages of 18 and 34 via machine learning techniques. For example, the site may deliver 100 ad impressions with 80% probability that the ads belong to a female between the ages of 18 and 34, and 100 ad impressions with 90% probability that the ads belong to a female between the ages of 18 and 34. Assuming the 80% and 90% probabilities are correct, the site will charge for 170 (100*80%+100*90%=170) ad impressions.

The precision of the ad targeting may be how confident the site is that the targeted audience viewed the advertisement. Typically, a site offers a single level of precision. For example, if the probability of over 70%, the site considers the ad targeted. An advertiser can select from an offering of ad targeting or no ad targeting.

### SUMMARY

In one embodiment, a method provides a first level of ad targeting and a second level of ad targeting by determining advertisement (ad) impressions previously determined for a site and respective predicted probabilities determined for the ad impressions. A predicted probability is a probability that an ad impression belongs to a segment that is being targeted. A mapping table is generated mapping predicted probabilities to respective precisions using seed data associated with the ad impressions where the seed data including features for users associated with the ad impressions. The method generates optimal options for using the first level and the second level for the segment using the mapping table. The optimal options including a first precision for the first level that is greater than a second precision for the second level and a ratio of ad inventories allocated to the first level and the second level. Then the method selects one of the optimal options. The selected one of the optimal options includes parameters including a first threshold for the first level, a second threshold for the second level, and the ratio that are used to test whether a predicted probability for an ad impression is targeted to the first level or the second level.

In one embodiment, a non-transitory computer-readable storage medium contains instructions for providing a first level of ad targeting and a second level of ad targeting, wherein the instructions, when executed, control a computer system to be configured for: determining advertisement (ad) impressions previously determined for a site and respective predicted probabilities determined for the ad impressions, wherein a predicted probability is a probability that an ad impression belongs to a segment that is being targeted; generating a mapping table mapping predicted probabilities to respective precisions using seed data associated with the ad impressions, the seed data including features for users associated with the ad impressions; generating optimal options for using the first level and the second level for the segment using the mapping table, the optimal options including a first precision for the first level that is greater than a second precision for the second level and a ratio of ad inventories allocated to the first level and the second level; and selecting one of the optimal options, wherein the selected one of the optimal options comprise parameters indicating a first threshold for the first level, a second threshold for the second level, and the ratio that are used to test whether a predicted probability for an ad impression is targeted to the first level or the second level.

In one embodiment, an apparatus configured to provide a first level of ad targeting and a second level of ad targeting includes: one or more computer processors; and a non-transitory computer-readable storage medium comprising instructions, that when executed, control the one or more computer processors to be configured for: determining advertisement (ad) impressions previously determined for a site and respective predicted probabilities determined for the ad impressions, wherein a predicted probability is a probability that an ad impression belongs to a segment that is being targeted; generating a mapping table mapping predicted probabilities to respective precisions using seed data associated with the ad impressions, the seed data including features for users associated with the ad impressions; generating optimal options for using the first level and the second level for the segment using the mapping table, the optimal options including a first precision for the first level that is greater than a second precision for the second level and a ratio of ad inventories allocated to the first level and the second level; and selecting one of the optimal options, wherein the selected one of the optimal options comprise parameters including a first threshold for the first level, a second threshold for the second level, and the ratio that are used to test whether a predicted probability for an ad impression is targeted to the first level or the second level.

The following detailed description and accompanying drawings provide a better understanding of the nature and advantages of particular embodiments.

### BRIEF DESCRIPTION OF THE DRAWINGS

FIG. 1 depicts an ad targeting system using multiple precisions according to one embodiment.

FIG. 2 depicts a simplified flowchart of a method for generating optimal combinations for multiple precisions according to one embodiment.

FIG. 3 shows a table of an example of a mapping from predicted probability to precision according to one embodiment.

FIG. 4 depicts an example of a table showing optimal options according to one embodiment.

FIG. 5 depicts the relationship between the total inventory and the inventory of two targeting levels according to one embodiment.

FIG. 6 shows an example of pseudocode that could be used to generate the optimal options according to one embodiment.

FIG. 7 depicts a simplified flowchart of the method for determining whether an ad is qualified for any targeting level according to one embodiment.

FIG. 8 depicts a video streaming system in communication with multiple client devices via one or more communication networks according to one embodiment.

FIG. 9 depicts a diagrammatic view of an apparatus including the ad targeting system.

### DETAILED DESCRIPTION

Described herein are techniques for an ad targeting system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

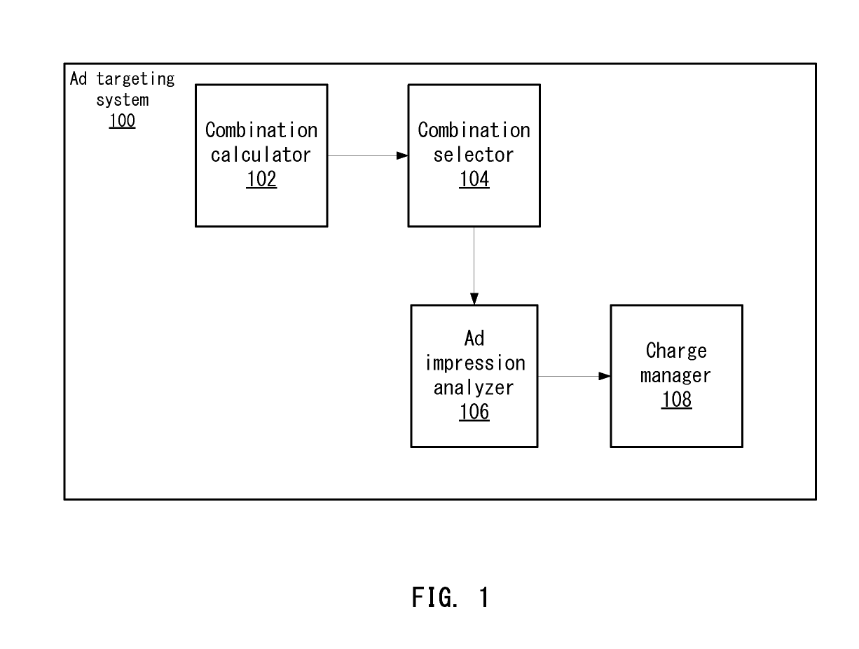

FIG. 1 depicts an ad targeting system 100 using multiple precisions according to one embodiment. Ad targeting system 100 may be used to determine multiple precisions for ad targeting that can be used in targeting certain features, such as demographics of user. The ad targeting may be performed on a site that offers a variety of videos to users. The videos include ad slots for playing ads to users to view. An ad impression results each time an ad is played during an ad slot. An example of a video transmission system will be described in more detail below.

Some advertisers/ad campaigns may desire different targeting precision. For example, an advertiser may desire that an ad about violence or sports is delivered to only males. In this case, the advertiser may want to use demographic targeting to males with a high precision. This means that the advertiser is only charged for the ad when it is delivered to a male with a high probability. However, for some advertisers, a lower precision is desired. In this case, the advertisers may not be as concerned that the ad be delivered to the targeted audience. The site may charge less for having a lower precision.

Accordingly, the site may offer multiple levels of ad targeting. For example, the site may offer a first level of demographic targeting and a second level of demographic targeting. It should be noted that although demographic targeting is discussed, other features may be targeted, such as behavior targeting and user interest targeting. The first level may be referred to as guaranteed demographic targeting and the second level may be referred to as un-guaranteed demographic targeting. Although guaranteed and un-guaranteed are used, these terms represent different levels and stating a level is un-guaranteed does not mean something is not guaranteed. Rather, the levels represent that the precision of the guaranteed demographic targeting is higher than the precision of the un-guaranteed demographic targeting. Also, the precision of the un-guaranteed demographic targeting may be higher than another precision, such as run-of-site (ROS) precision. The run-of-site may be based on ad impressions across all the videos offered by the site.

The site may charge differently for the different levels of targeting. For example, the first level, the guaranteed demographic targeting, may be charged only when the ad impression is considered targeted to the audience. Also, the second level of targeting, the un-guaranteed demographic targeting, may be charged by a different method, such as by cost per 1000 impressions, cost per mile (CPM), or other methods. The second level of charging may be charging for ads that are not considered targeted to the first level, but may be above the level for run-of-site ad impressions.

In ad targeting, system 100 uses a predictive model to predict the probability (e.g., 0.0 to 1.0) that a user who viewed the ad impression belongs to a segment. The segment may be some feature that is being targeted, such as females between the ages of 18 and 34. Whether that ad impression will be determined to be targeted or not depends on a threshold that is used to determine whether or not the ad is targeted. For example, if the probability is over the threshold, then system 100 considers the ad impression targeted. However, if the probability is below a threshold, then system 100 considers the ad not targeted to the segment. There is a trade-off between coverage (e.g., ad inventory) and precision that can be changed by adjusting the threshold. For example, if the site decreases the threshold, more ad inventory is reached, but the precision will decrease. However, if the threshold is increased, less ad inventory is reached, but the precision increases. That is, when more ad inventory is reached, that means that more ad slots are deemed to be targeted. However, the precision decreases because there is less probability that the ad impression belongs to the segment.

System 100 balances the trade-off between the coverage and the precision to determine multiple thresholds that can be used for ad targeting. To evaluate the trade-off, system 100 generates optimal combinations of options for the multiple precisions. System 100 adjusts parameters, such as the two thresholds and a take up ratio, to generate the optimal combinations. The take up ratio is used to balance the trade-off of allotting inventory between the first level of targeting and the second level of targeting and will be described in more detail below. Then, system 100 may select one of the optimal combinations based on some criteria, such as a business requirement.

In system 100, a combination calculator 102 is configured to determine the optimal options for multiple precision ad targeting. By generating optimal options, the total inventory is divided without waste. The ad targeting data will be described in more detail below but can include previous data that is collected from ad impressions that occurred on the site and/or data regarding precision from third-party information. For example, combination calculator 102 receives ad targeting data and outputs optimal combinations that include different combinations of ad inventory coverage and precision for multiple precisions. For example, if higher precision or more ad inventory for one level is desired, then the precision and ad inventory of other levels are affected, such as requiring more ad inventory for one level will mean less ad inventory for another level. The generation of optimal combinations will be described in more detail below.

A combination selector 104 selects one of the combinations based on a criterion, such as a business requirement. For example, the site may desire that the first level of targeting have a certain precision or reach a certain amount of ad inventory. In other embodiments, an input may be received that is used by combination selector 104 to select one of the combinations.

Combination selector 104 selects one of the combinations and outputs the parameters for the combination to an ad impression analyzer 106. The selection includes one precision for each targeting level by considering the trade-off between the precision and the inventory amount for each targeting level. After that, each targeting level only has fixed precision and inventory amount. Once the precisions are selected, the parameters may include the probability thresholds that should be used to determine whether or not an ad impression is targeted to one of the levels of ad targeting. Additionally, a take up ratio (take_up_ratio) for each ad targeting level is provided that references how much inventory is used for each probability threshold. The take up ratio is used because it is possible not all ad inventory that falls above a probability threshold may be targeted to a respective level of targeting. Rather, some of that ad inventory may be allotted to a lower level of targeting.

Once selecting the parameters, ad targeting system 100 may analyze ad impressions. Ad impression analyzer 106 receives ad impressions and determines features associated with users that viewed the ad impressions. Ad impression analyzer 106 calculates a probability for the ad impression based on the user's features. Then, ad impression analyzer 106 compares the probability to the thresholds to determine whether the ad impression should be associated with one of the levels. For example, if the probability is above a first threshold, then ad impression analyzer 106 determines the ad has a chance to be targeted to the first level, such as a guaranteed demographic. However, due to the take up ratio, some ads with a probability above the first threshold may not be targeted to the first level, but rather the second level. If the probability is below the first threshold, but above the second threshold, then ad impression analyzer 106 may determine that the ad impression is associated with the second level, such as an un-guaranteed demographic. Further, if the probability is below the second threshold, then ad impression analyzer 106 may determine that this ad does not qualify for the first or second levels, and may be run-of-site.

Ad impression analyzer 106 outputs the level associated with the ad impression to a charge manager 108. Charge manager 108 then determines a charge for the ad impression. For example, charge manager 108 may charge the ad impression for the first level at a first rate, charge the ad impression for the second level at a second rate, and charge the ad impression for the third level at a third rate. It will be understood that charge manager 108 may be part of a third party site that verifies the charges independently of the site.

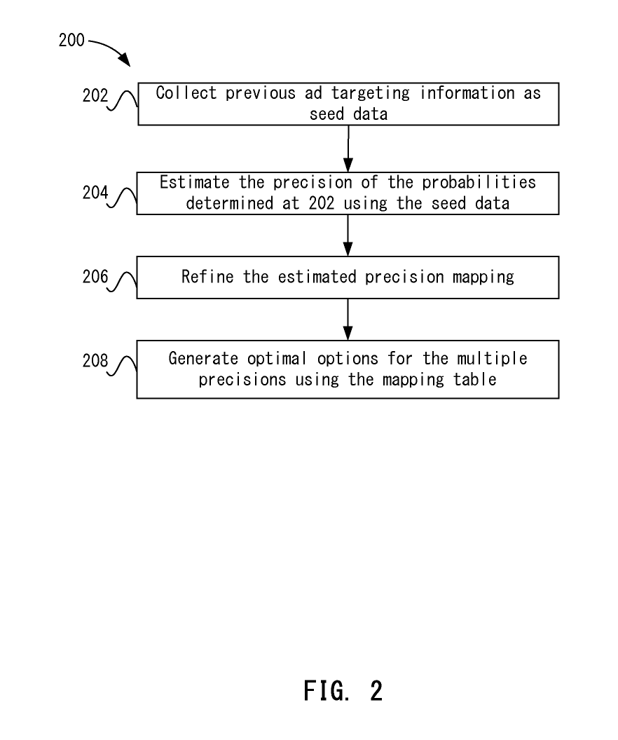

As described above, system 100 generates optimal combinations and this process will be described in more detail. FIG. 2 depicts a simplified flowchart 200 of a method for generating optimal combinations for multiple precisions according to one embodiment. At 202, combination calculator 102 collects previous ad targeting information as seed data. For example, for each ad impression over a certain time limit for the site, such as the last month, months, year, etc., the site may determine the probability calculated for each ad impression that a user who viewed the ad impression belongs to the segment being targeted. In one embodiment, combination calculator 102 may determine the probability values calculated for each ad impression of the last month. The above data may be determined using logs of ad impressions on the site.

At 204, combination calculator 102 estimates the precision of the probabilities determined at 202 using the seed data. In one embodiment, combination calculator 102 may use a predictive model to determine the precision. The seed data may be used as a training set for the predictive model. For example, in demographic targeting, registered users for the site include profile information that is provided during registration that may be used as seed data. For the registered users, combination calculator 102 knows whether the users belong to some segment, such as females between the ages of 18 and 34, or not exactly (e.g., a female, but the age is not known). However, combination calculator 102 may still predict the probabilities for these users that they belong to the segment. For example, even though the registered user is a female between the ages of 18 and 34, combination calculator 102 calculates the probability. In this way, combination calculator 102 can map from the predicted probability to a precision. For example, if the predicted probability is within 0.80 and 0.81, the precision is 75%.

The precision is 75% because combination calculator 102 knows that 75% of the ad impressions were targeted to a female between the ages of 18 and 34 based on the registered user information. In one embodiment, combination calculator 102 calculates the mapping from predicted probability to precision based on registered users only using the information that is known for the registered users. First, combination calculator 102 assumes the profiles of registered users are trustable, and the profiles are used as seed (training) data in the predictive model (e.g., a machine learning algorithm) for predicting the probability. Second, for the registered users, combination calculator 102 calculates the probabilities that the registered users belong to the targeted level using the predictive model. Third, combination calculator 102 determines which registered users have a predicted probability of 0.80 and 0.81 and belong to the targeted segment. For example, combination calculator 102 knows whether any registered user belongs to the segment or not because combination calculator 102 knows the user's profile information. So the precision of predicted probability [0.80, 0.81] is an ‘amount of the registered users that belong to the target (and with predicted probability within [0.80, 0.81])’ over an ‘amount of the total registered users (with predicted probability within [0.80, 0.81])’. This generates the mapping table (from predicted probability to precision). Then, combination calculator 102 can calculate the predicted probability of anonymous users using the predictive model, and the precision can be calculated using this mapping table.

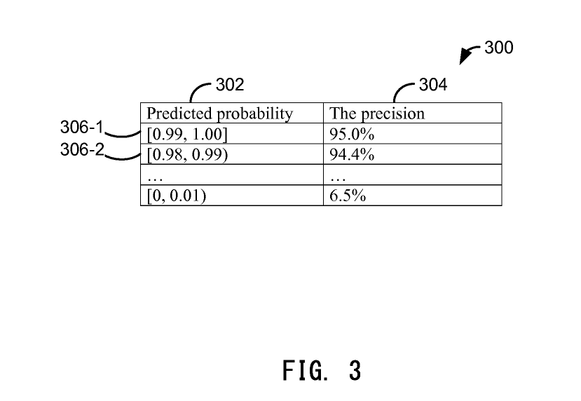

FIG. 3 shows a table 300 of an example of a mapping from predicted probability to precision according to one embodiment. A column 302 shows a predicted probability and a column 304 shows the precision. For each predicted probability, combination calculator 102 maps a corresponding precision. For example, in a row 306-1, if the predicted probability is 0.99-1.00, then the precision is 95.0%. Similarly, in a row 306-2, if the predicted probability is 0.98-0.99, the corresponding precision is 94.4%. Other predicted probabilities and precisions are then mapped in table 300.

From the mapping generated from the seed data, combination calculator 102 can map the precision of ad impressions from anonymous users (or other users in which enough features are not known to determine whether they belong to the segment) from a probability to a precision. For example, if an anonymous user in which the feature characteristics of the segment are not known (e.g., combination calculator 102 does not know whether the user is a female or the age), combination calculator 102 can map the predicted probability to a precision based on table 300. In one example, combination calculator 102 may know that the user has watched a show called “Family Guy”, and maps this feature to a probability. Then, combination calculator 102 maps this probability to a precision based on table 300.

Referring back to FIG. 2, at 206, combination calculator 102 may refine the estimated precision mapping determined in FIG. 3 according to one embodiment. This step may not be performed in some embodiments. However, in some cases, combination calculator 102 may refine the mapping from the probability to the precision using other information, such as third-party information from other companies. For example, the mapping from the predicted probability to the precision based on the registered users' profile information may not be as precise as desired. In this case, combination calculator 102 may refine the mapping based on data from other third-party companies, such as television online information that is used to measure demographic targeting precision.

At 208, combination calculator 102 generates optimal options for the multiple precisions using the mapping table. The optimal options balance between precision and inventory for the multiple levels of targeting. For example, if a higher precision is desired, then the ad inventory will be affected, and vice versa. Two levels, P_A and P_B, will be used in an example, but it will be understood that more levels may be used. In one embodiment, a precision of the level P_A is higher than a precision of the level P_B and both levels P_A and P_B share parts of the total ad inventory. Thus, there is competition between levels P_A and P_B for the ad inventory. That is, if a higher precision or inventory for the level P_A is desired, then the precision and inventory for the level P_B will be impacted. Further, if a higher precision or inventory for the level P_B is desired, then the precision and inventory for the level P_A will be affected.

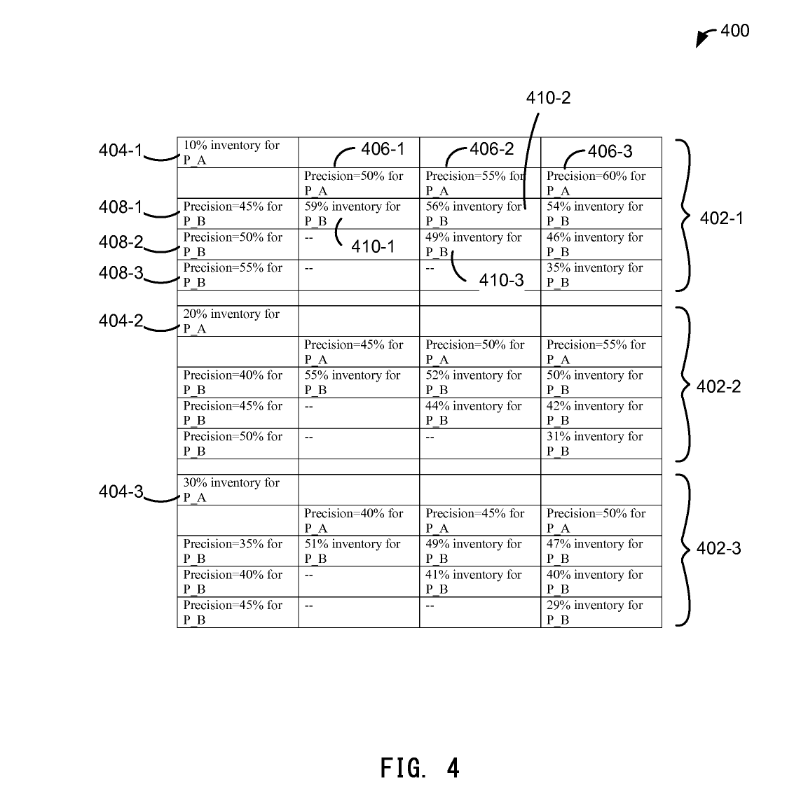

Combination calculator 102 determines optimal options for different variations of the precisions P_A and P_B. In one embodiment, combination calculator 102 generates all optimal options for a combination of precisions and inventory based on the mapping table. Generation of the optimal options allows the site to see how different combinations of precision and ad inventory work together and one option can be selected based on a business requirement. FIG. 4 depicts an example of a table 400 showing optimal options according to one embodiment. Some restrictions are imposed to generate the options. An example of some restrictions includes:
The precision of targeting level P_A should be higher than the precision of targeting level P_B;
The precision of targeting level P_B should be higher than some minimum value (e.g., the precision of the ROS distribution);
The inventory of targeting level P_A should be at least 10% of total inventory;
The inventory of targeting level P_B should be at least 20% of total inventory.

In table 400, optimal combinations are shown at 402-1, 402-2, and 402-3. Other optimal combinations may also be appreciated, but are not shown. For each optimal combination 402-1-402-3, an inventory for targeting level P_A is shown at 404-1-404-3, respectively. For example, due the third restriction, inventory 404-1 starts at a 10% inventory because precision P_A should be at least 10% of total inventory. Also, for precision P_A, inventory 404-2 shows a 20% inventory for precision P_A, and inventory 404-3 shows a 30% inventory for a precision P_A. The percentage of inventory indicates the amount of inventory desired to be allocated for each precision. For combination 402-1, different precisions for precision P_A are shown at 406-1, 406-2, and 406-3 and corresponding precisions for precision P_B are shown at 408-1-408-3. Other precisions may also be appreciated.

Combination calculator 102 determines the precisions based on the inventory selected for precision P_A at 404-1. The combinations show different variations of ad inventory and precision. For example, at 410-1, if the precision is 50% for precision P_A and the precision is 45% for precision P_B, then the amount of inventory allotted to precision P_B is 59%. If the desired precision for precision P_A is increased to 55%, then the inventory available for precision P_B at a precision of 45% is reduced to 56%. The inventory for precision P_B decreases because the inventory for the level P_A is stable at 10%. The inventory of P_B decreases because the inventory above threshold B is the sum inventory of the levels P_A and P_B. If precision of the level P_A increases while the inventory for the level P_A remains unchanged, then the precision of the level P_B will decrease if the inventory for the level P_B remains unchanged also. However, in this case, the precision of the level P_B remains stable, so the threshold Thre_B has to be increased to keep precision of the level P_B stable. So, the inventory of the level P_B will decrease. Also, if the precision for the level P_B is increased from 45% to 50%, then at 410-3, the inventory for precision P_B decreases to 49%. As the precision of the level P_A remains stable, then threshold Thre_A remains unchanged. As the inventory of the level P_A remains stable, then the take up ratio remains stable. If the precision of the level P_B is increased, combination calculator 102 has to increase the threshold Thre_B, which will lead the inventory of the level P_B to decrease. That is, the inventory is ranked by predicted probability (similar with ranking by precision). So, he precision increases and the inventory will decrease if the threshold is increased, and vice versa.

For optimal combination 402-2, different combinations are shown. Because inventory for the level P_A is increased, more inventories are reached and thus precision decreases, which is why precisions of 45%, 50%, and 55% are shown for the 20% inventory. The precision decreases as the precision of ad inventory reached for the increased inventories is lower. Further, the inventory that can be allotted to the level P_B also changes. That is, when the inventory increases for precision P_A, the inventory available for the level P_B decreases. Increasing the inventory for the level P_A means that more ad impressions will be deemed targeted to the level P_A. This will allow the site to charge for ad impressions that are deemed targeted to the level P_A. However, this means that less ad inventory is available to be charged for the level P_B.

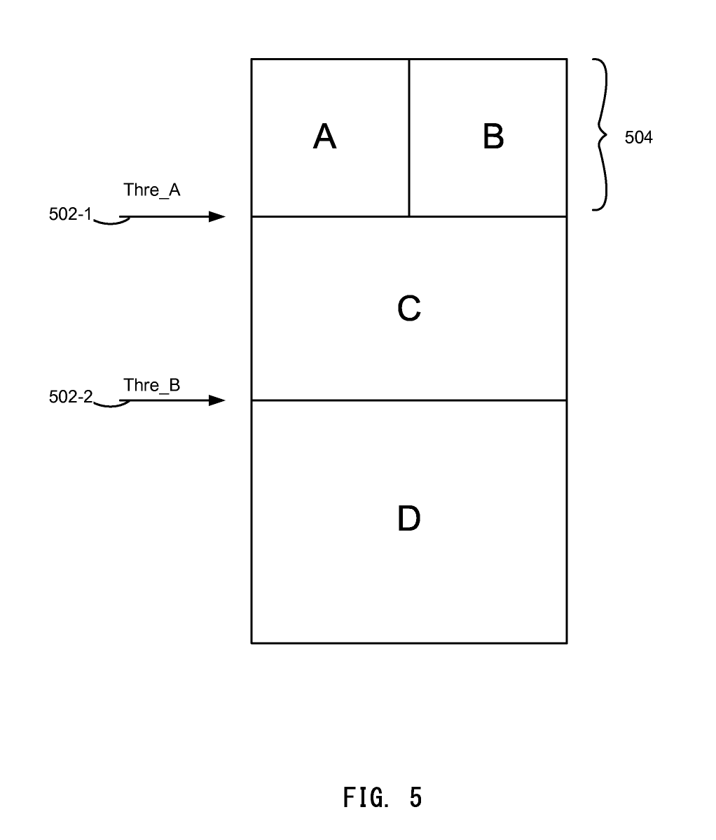

FIG. 5 depicts the relationship between the total inventory and the inventory of two targeting levels according to one embodiment. Combination calculator 102 generates thresholds for the multiple precisions based on the mapping table. For example, using the precisions and predicted probabilities in the mapping table, combination calculator 102 can determine the thresholds to realize the precisions and allotted ad inventory to the two targeting levels. As discussed above, ad impression analyzer 106 uses the thresholds to determine whether a predicted probability is targeted or not. At 502-1, a first threshold Thre_A is shown for a first level P_A and at 502-2, a second threshold Thre_B is shown for a second level P_B.

When a threshold Thre_A is selected for the level P_A according to the precision required, then the ad inventories A and B at 504 are the maximum coverage for precision P_A. If the required minimum coverage for the level P_A is larger than ad inventory A+ad inventory B, then the required precision for the level P_A needs to be lowered such that the threshold Thre_A is lower or the required coverage should be lowered. However, if ad inventory A is large enough to satisfy the inventory for the level P_A, then ad inventory B will be used for the level P_B. Also, ad inventory C can be allotted for the level P_B. The optimal combinations take these situations into account such that business requirements may be met by one of the combinations.

It is noted that the predicted probability of ad inventory B is above the threshold Thre_A. The following illustrates why this occurs. To generate the optimal options, for any desired precision of the level P_A, combination calculator 102 selects a threshold Thre_A for the level P_A. The inventory above threshold Thre_A is usually more than needed for the inventory needs of the level P_A. Thus, combination calculator 102 allots part of inventory above the threshold Thre_A for the level P_A. In this case, the allotted inventory is range A. The take up ratio is the equal to take_up_ratio=range A/(range A+range B). If the required inventory of the level P_A is bigger than inventory above threshold Thre_A, then combination calculator 102 will either lower the required precision or lower the required inventory.

For any desired precision of the level P_B, combination calculator 102 can choose threshold Thre_B. Then, the inventory of range B and range C is allotted for the level P_B. This provides the maximum inventory for the level P_B. If the required inventory of the level P_B is larger than the maximum inventory for the level P_B, combination calculator 102 will either lower the required precision or inventory of the level P_B. Finally, combination calculator 102 determines the inventory and precision for the levels P_A and P_B. The inventory for the level P_A is range A, and the precision is the average precision of range A. Also, the inventory for the level P_B is ‘Range B+Range C’, and the precision is ‘(Precision B*Range B+Precision C*Range C)/(Range B+Range C)’. This combines the precisions of range B and range C as the precisions are different in the ranges. In summary, combination calculator 102 fixes the desired inventory for the level P_A. Then, for each desired precision for the level P_A, the maximum inventory of the level P_B is determined automatically for each desired precision for the level P_B.

The above example divides the total inventory without waste given desired inventory and precision for the multiple levels of targeting. If optimal combinations were not generated, then ad inventory would be wasted. For example, in one suboptimal example, threshold A is chosen based on the required precision of the first level targeting (assuming the inventory above threshold A is more than desired inventory of first level targeting). Then, threshold B is chosen for a second level targeting (assume the inventory between threshold A and B is more than desired inventory of second level targeting). In this example, the inventory above threshold A may be more than the required inventory, so this inventory is wasted.

In one example, threshold Thre_A is 0.76, threshold Thre_B is 0.45, and the take up ratio for precision P_A is 0.7. With these parameters determined, the required coverage and precision for precisions P_A and P_B are reached.

The following will describe the generation of optimal combinations in more detail. All ad impressions from previous data as described at 202 in FIG. 2 are ranked by predicted probability (e.g., 1.0 on the top to 0.0 on the bottom) in mapping table 300. Metrics for the precision of the level P_A, the precision for the level P_B, and the coverage (e.g., the percentage of ad inventory) for the levels P_A and P_B, respectively, are determined. Additionally, the site may have some criteria for the metrics. The criteria may include restrictions may include the relationships between the levels P_A and P_B or the coverage of the total inventory. An example of some restrictions includes:
The precision of the level P_A should be higher than the precision of the level P_B;
The precision of the level P_B should be higher than some minimum value (e.g., the precision of the ROS distribution);
The coverage of the level P_A should be at least 10% of total inventory;
The coverage of the level P_B should be at least 20% of total inventory.

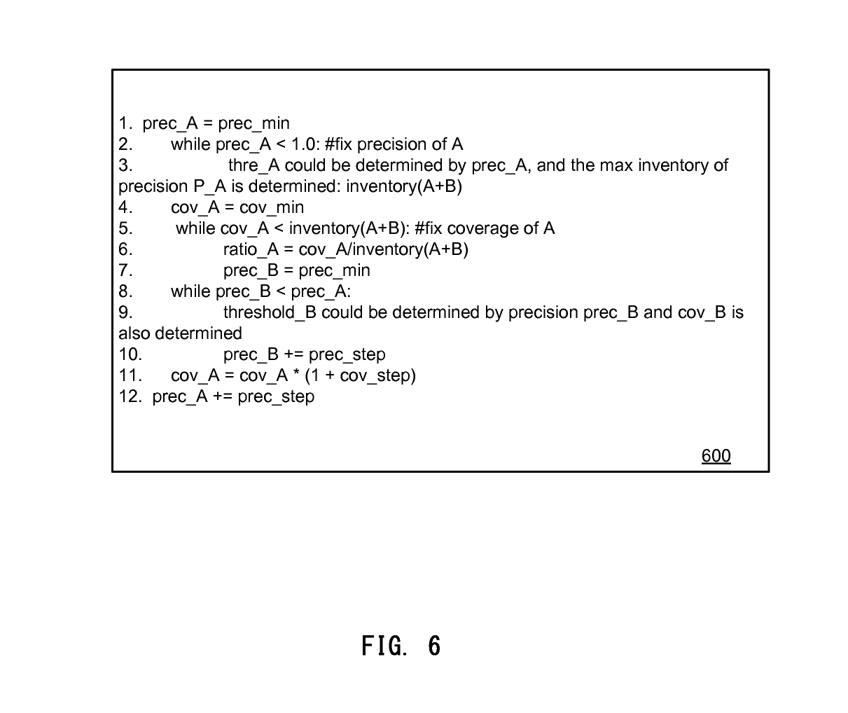

Once determining the restrictions, combination calculator 102 generates the optimal options using mapping table 300. FIG. 6 shows an example of pseudocode that could be used to generate the optimal options according to one embodiment. The following parameters are described in the pseudocode as follows:

prec_A: the precision of P_A
prec_B: the precision of P_B
cov_A: coverage of P_A
cov_B: coverage of P_B
prec_min: minimum precision required
prec_step: interval of precision of different options (e.g., 5%, but could be other percentages)
cov_min: minimum coverage required
thre_A: the probability threshold chosen for P_A
thre_B: the probability threshold chosen for P_B
ratio_A: the percentage of inventory taken up by P_A
cov_step: interval of inventory of different options (e.g., 1%)

In line 1 of the pseudocode, the precision of the level P_A is set to a minimum value prec_min. This is the minimum precision required for the guaranteed ad targeting level. Then, in line 2, combination calculator 102 determines when the precision of the level P_A is less than 1.0 (i.e., 100% or the maximum precision), the threshold Thre_A that could be determined by the precision prec_A using mapping table 300. Also, combination calculator 102 determines the maximum inventory of the level P_A (e.g., A+B) using mapping table 300. Because all optimal options will be generated, combination calculator 102 tests multiple values for precision A. With the precision fixed, combination calculator 102 determines the threshold Thre_A, and combination calculator 102 determines the maximum inventory for the level P_A. The maximum inventory may be the amount of inventory that is reached by having a probability above the threshold Thre_A.

In a line 4, the coverage of the level P_A is set equal to the minimum coverage required of cov_min. In line 5, combination calculator 102 determines when the coverage cov_A is less than the maximum inventory (inventory A+B). When this is true, combination calculator 102 executes lines 6 and 7 to determine a ratio, ratio_A, that is the percentage of inventory taken up by the precision P_A using mapping table 300. The ratio ratio_A is calculated as the coverage, cov_A/inventory (A+B). Also, in line 7, combination calculator 102 sets the precision prec_B of the level P_B to the value of the minimum precision required prec_min. In line 8, combination calculator 102 tests whether the precision prec_B is less than the precision of prec_A. When this is true, in line 9, combination calculator 102 determines the threshold Thre_B using the precision prec_B, and also determines the coverage of the level P_B of cov_B using mapping table 300. In this case, the level P_A has already taken up inventory A, and combination calculator 102 knows the required precision for level P_B, and can determine a threshold Thre_B for level P_B using mapping table 300. For example, when combination calculator 102 moves the threshold Thre_B down from threshold Thre_A to 0, the precision of level P_B will keep decreasing and its inventory keep increasing. As combination calculator 102 knows the required precision for the level P_B, combination calculator 102 finds only one threshold satisfies the required precision. Thus, the inventory/coverage of the level P_B is the range (B+C).

In line 10, combination calculator 102 increases the precision prec_B by a certain amount indicated by prec_step. In line 11, the coverage of the level P_A is increased by a step of cov_A*(1+cov_step). Also, in line 12, the precision prec_A is increased by the same precision step, prec_step. The process then continues to generate another set of optimal options of the levels P_A and P_B given the new values for the precisions and coverage.

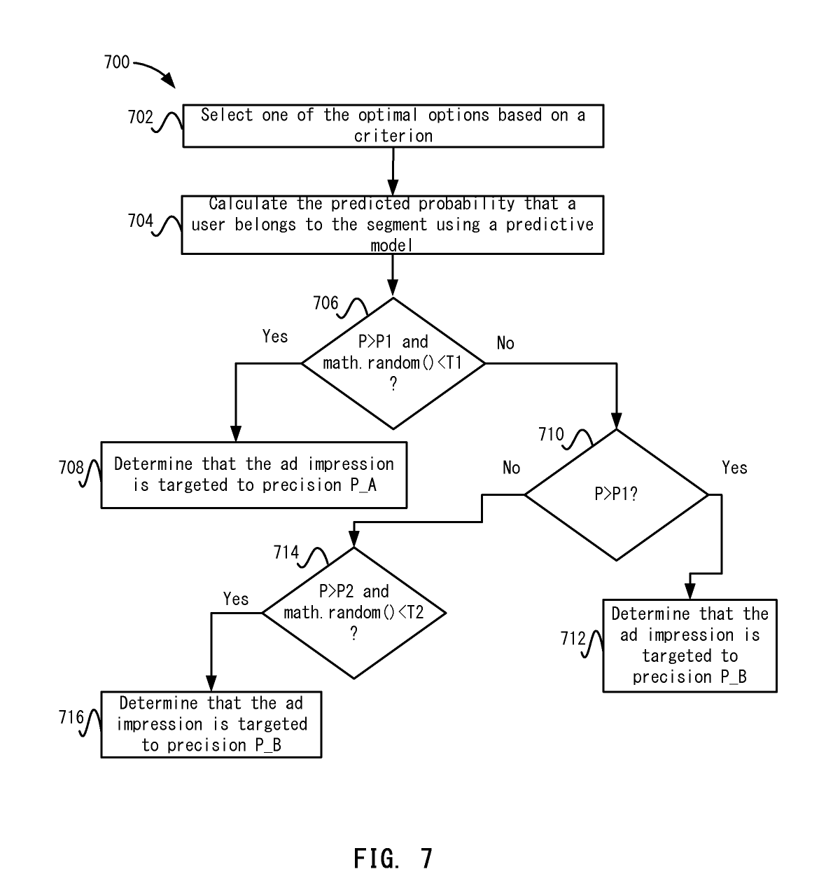

Once all the optimal options are generated, combination calculator 102 outputs the optimal combinations. Then, the process of analyzing ad impressions can use the parameters of the chosen option. FIG. 7 depicts a simplified flowchart of the method for evaluating ad impressions according to one embodiment. At 702, option selector 104 selects one of the optimal options based on a criterion. For example, option selector 104 selects one of the optimal options based on a business requirement for the site, such as the site may desire a certain amount of inventory or precision for the level P_A or a certain amount of inventory or precision for the level P_B. Option selector 104 may select the option based on input from a user selecting one of the options or based on requirements set by a user. After selecting one optimal combination, the parameters are known. For example, the probability thresholds for the level P_A and P_B may be referred to as P1 and P2, respectively. In one example, the probability thresholds may be 80% and 60%, respectively. Also, a take up ratio of the levels P_A and P_B are referred to as T1 and T2, respectively. Although two take up ratios are shown, if there are only have two different targeting levels, then there is only one take up ratio. The take up ratios are the percentage of inventory above a threshold that belong to the level. For example, not all inventory above the 80% threshold is for the level P_A. The take up ratio is the percentage of inventory above the 80% threshold that belongs to the level P_A. The same is true for the take up ratio T2 and the level P_B.

At 704, for an ad impression, ad impression analyzer 106 then calculates the predicted probability that a user belongs to the segment using a predictive model. This predicted probability may be referred to as a probability P.

Once the predicted probability is determined, at 706, ad impression analyzer 106 determines if the probability P is greater than the probability P1 (P>P1) and also that math.random( )T1. Math.random( ) is used to generate a random number between 0 and 1 and T1 is the take up ratio of P_A. Having a probability above the threshold means that the ad impression may be targeted to the level P_A; however, due to the take up ratio, some ad impressions with probabilities above the threshold may not be targeted to the level P_A. The random number is used to provide the required inventory for the level P_A. If the two above requirements are true, then at 708, ad impression analyzer 106 determines that the ad impression is targeted to the level P_A.

However, if the predicted probability P is greater than the threshold P1, but math.random( ) is not less than T1, then at 710, ad impression analyzer 106 determines that the ad impression is targeted to the level P_B. The reason why the ad impression is targeted to the level P_B is because the inventory above the threshold Thre_A is allotted to the level P_B.

If none of the above is true, then at 714, if the predicted probability P is greater than the threshold P2 and math.random( )T2, then at 716, ad impression analyzer 106 determines that the ad impression was targeted to precision P_B. In this case, if not all the inventory above the threshold P2 is allotted to the level P_B, math.random and the take up ratio T2 is used to determine if the ad impression is allotted to the level P_B. If there are only two levels, then this ad impression would be allotted to the level P_B because the predicted probability P is greater the threshold P1.

### System Overview

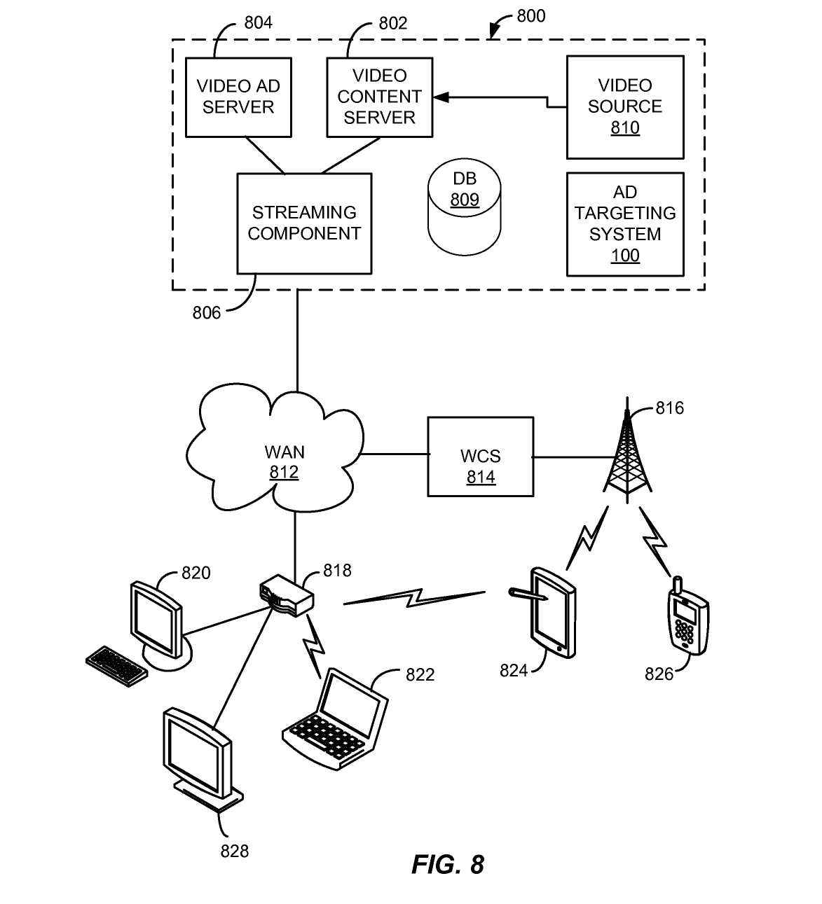

Features and aspects as disclosed herein may be implemented in conjunction with a video streaming system 800 in communication with multiple client devices via one or more communication networks as shown in FIG. 8. Aspects of the video streaming system 800 are described merely to provide an example of an application for enabling distribution of content prepared according to the present disclosure. It should be appreciated that the present technology is not limited to streaming video applications, and may be adapted for other applications.

Video data may be obtained from one or more sources for example, from a video source 810, for use as input to a video content server 802. The input video data may comprise raw or edited frame-based video data in any suitable digital format, for example, MPEG-1, MPEG-2, MPEG-4, VC-1, or other format. In an alternative, a video may be provided in a non-digital format and converted to digital format using a scanner and/or transcoder. The input video data may comprise video clips or programs of various types, for example, television episodes, motion pictures, and other content produced as primary content of interest to consumers.

The video streaming system 800 may include one or more computer servers or modules 802, 804, and/or 806 distributed over one or more computers. Each server 802, 804, 806 may include, or may be operatively coupled to, one or more data stores 809, for example databases, indexes, files, or other data structures. A video content server 802 may access a data store (not shown) of various video segments. The video content server 802 may serve the video segments as directed by a user interface controller communicating with a client device. As used herein, a video segment refers to a definite portion of frame-based video data, such as may be used in a streaming video session to view a television episode, motion picture, recorded live performance, or other video content.

In some embodiments, a video advertising server 804 may access a data store of relatively short videos (e.g., 10 second, 30 second, or 60 second video advertisements) configured as advertising for a particular advertiser or message. The advertising may be provided for an advertiser in exchange for payment of some kind, or may comprise a promotional message for the system 800, a public service message, or some other information. The ad server 804 may serve the video advertising segments as directed by a user interface controller (not shown).

The video streaming system 800 also may include ad targeting system 100. As described above, ad targeting system 100 generates combinations for multiple precisions. Also, ad analysis system 100 receives information for ad impressions from video ad server 604, or other components, and analyzes the ad impressions based on a selected combination.

The video streaming system 800 may further include an integration and streaming component 806 that integrates video content and video advertising into a streaming video segment. A controller (not shown) may determine the selection or configuration of advertising in the streaming video based on any suitable algorithm or process. The video streaming system 800 may include other modules or units not depicted in FIG. 8, for example administrative servers, commerce servers, network infrastructure, advertising selection engines, and so forth.

The video streaming system 800 may connect to a data communication network 812. A data communication network 812 may comprise a local area network (LAN), a wide area network (WAN), for example, the Internet, a telephone network, a wireless cellular telecommunications network 814, or some combination of these or similar networks.

One or more client devices may be in communication with the video streaming system 800, via the data communication network 812 and/or other network 814. Such client devices may include, for example, one or more laptop computers 822, desktop computers 820, “smart” mobile phones 826, notepad devices 824, network-enabled televisions 828, or combinations thereof, via a router 818 for a LAN, via a base station 816 for a wireless telephony network 814, or via some other connection. In operation, such client devices 820, 822, 824, 826, or 828 may send and receive data or instructions to the system 800, in response to user input received from user input devices or other input. In response, the system 800 may serve video segments and metadata from the data store 809 responsive to selection of interactive links to the client devices 820, 822, 824, 826, or 828 and customize the additional content based on parameters of the client devices, for example respective geographic locations of the client devices, or demographic information concerning respective users of the client devices. The devices 820, 822, 824, 826, or 828 may output interactive video content from the streaming video segment using a display screen, projector, or other video output device, and receive user input for interacting with the video content based on one or more links associated with a tracked face or other object appearing in the video content.

Distribution of audio-video data may be implemented from streaming component 806, such as a content server or streaming media server, to remote client devices over computer networks, telecommunications networks, and combinations of such networks, using various methods, for example streaming. In streaming, a server streams audio-video data continuously to a media player component operating at least partly on the client device, which may play the audio-video data concurrently with receiving the streaming data from the server. Although streaming is discussed, other methods of delivery may be used. The media player component may initiate play of the video data immediately after receiving an initial portion of the data from the content provider. Traditional streaming techniques use a single provider delivering a stream of data to a set of end users. High bandwidths and processing power may be required to deliver a single stream to a large audience, and the required bandwidth of the provider may increase as the number of end users increases.

Streaming media can be delivered on-demand or live. Streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities via a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player on the destination client. Unlike the web server, the streaming media server may communicate with the client device using control messages and data messages to adjust to changing network conditions as the video is played. These control messages can include commands for enabling control functions such as fast forward, fast reverse, pausing, or seeking to a particular part of the file at the client.

Since a streaming media server transmits video data only as needed and at the rate that is needed, precise control over the number of streams served can be maintained. The viewer will not be able to view high data rate videos over a lower data rate transmission medium. However, streaming media servers (1) provide users random access to the video file, (2) allow monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming media servers may use HTTP and TCP to deliver video streams, but generally use RSTP (real time streaming protocol) and UDP (user datagram protocol). These protocols permit control messages and save bandwidth by reducing overhead. Unlike TCP, when data is dropped during transmission, UDP does not transmit resent requests. Instead, the server continues to send data. Streaming media servers can also deliver live webcasts and can multicast, which allows more than one client to tune into a single stream, thus saving bandwidth. Streaming media players may not rely on buffering to provide random access to any point in the media program. Instead, this is accomplished through the use of control messages transmitted from the media player to the streaming media server. Another protocol used for streaming is hypertext transfer protocol (HTTP) live streaming (HLS). The HLS protocol delivers video over HTTP via a playlist of small segments that are made available in a variety of bitrates typically from one or more content delivery networks (CDNs). This allows a media player to switch both bitrates and content sources on a segment-by-segment basis. The switching helps compensate for network bandwidth variances and also infrastructure failures that may occur during playback of the video.

The delivery of video content by streaming may be accomplished under a variety of models. In one model, the user pays for the viewing of each video program, for example, using a pay-per-view service. In another model widely adopted by broadcast television shortly after its inception, sponsors pay for the presentation of the media program in exchange for the right to present advertisements during or adjacent to the presentation of the program. In some models, advertisements are inserted at predetermined times in a video program, which times may be referred to as “ad slots” or “ad breaks.” With streaming video, the media player may be configured so that the client device cannot play the video without also playing predetermined advertisements during the designated ad slots.

Output from a media player on the client device may occupy only a portion of total screen area available on a client device, particularly when bandwidth limitations restrict the resolution of streaming video. Although media players often include a “full screen” viewing option, many users prefer to watch video in a display area smaller than full screen, depending on the available video resolution. Accordingly, the video may appear in a relatively small area or window of an available display area, leaving unused areas. A video provider may occupy the unused area with other content or interface objects, including additional advertising, such as, for example, banner ads. Banner ads or similar additional content may be provided with links to an additional web site or page, so that when a user “clicks on” or otherwise selects the banner ad, the additional web site or page opens in a new window. Additional screen space, when available, may also be used for displaying additional information responsive to selection of links associated with face tracks in video content, as described in more detail elsewhere herein.

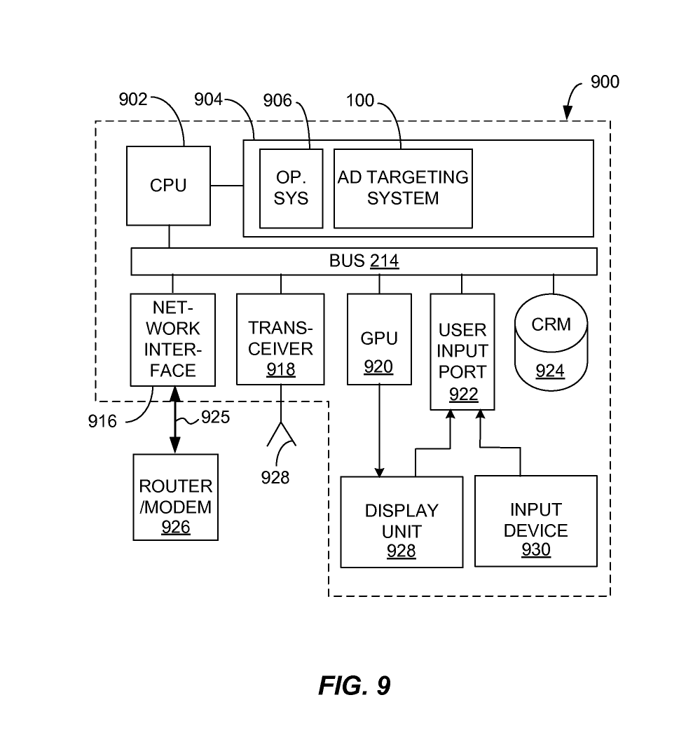

Referring to FIG. 9, a diagrammatic view of an apparatus 900 for ad targeting system 100 is illustrated. In selected embodiments, the apparatus 900 may include a processor 902 operatively coupled to a processor memory 904, which holds binary-coded functional modules for execution by the processor 902. Such functional modules may include an operating system 906 for handling system functions such as input/output and memory access, and ad targeting system 100. The memory 904 may hold additional modules not shown in FIG. 9, for example modules for performing other operations described elsewhere herein.

A bus 914 or other communication component may support communication of information within the apparatus 900. The processor 902 may be a specialized or dedicated microprocessor configured to perform particular tasks in accordance with the features and aspects disclosed herein by executing machine-readable software code defining the particular tasks. Processor memory 904 (e.g., random access memory (RAM) or other dynamic storage device) may be connected to the bus 914 or directly to the processor 902, and store information and instructions to be executed by a processor 902. The memory 904 may also store temporary variables or other intermediate information during execution of such instructions.

A computer-readable medium in a storage device 924 may be connected to the bus 914 and store static information and instructions for the processor 902; for example, the storage device 924 may store the modules 906 and 100 when the apparatus 900 is powered off, from which the modules may be loaded into the processor memory 904 when the apparatus 900 is powered up. The storage device 924 may include a non-transitory computer-readable storage medium holding information, instructions, or some combination thereof, for example instructions that when executed by the processor 902, cause the apparatus 900 to be configured to perform one or more operations of a method as described herein.

A communication interface 916 may also be connected to the bus 914. The communication interface 916 may provide or support two-way data communication between the apparatus 900 and one or more external devices, optionally via a router/modem 926 and a wired or wireless connection 925. In the alternative, or in addition, the apparatus 900 may include a transceiver 918 connected to an antenna 928, through which the apparatus 900 may communicate wirelessly with a base station for a wireless communication system or with the router/modem 926. In another alternative, the apparatus 900 may be incorporated as a module or component of the system 800 and communicate with other components via the bus 914 or by some other modality.

The apparatus 900 may be connected (e.g., via the bus 914 and graphics processing unit 920) to a display unit 928. A display 928 may include any suitable configuration for displaying information to an operator of the apparatus 900. For example, a display 928 may include or utilize a liquid crystal display (LCD), touchscreen LCD (e.g., capacitive display), light emitting diode (LED) display, projector, or other display device to present information to a user of the apparatus 900 in a visual display.

One or more input devices 930 (e.g., an alphanumeric keyboard, microphone, keypad, remote controller, game controller, camera or camera array) may be connected to the bus 914 via a user input port 922 to communicate information and commands to the apparatus 900. In selected embodiments, an input device 930 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 928, for example using a touch sensitive screen. A cursor control device may communicate direction information and command selections to the processor 902 and control cursor movement on the display 928. A cursor control device may have two or more degrees of freedom, for example allowing the device to specify cursor positions in a plane or three-dimensional space.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be configured to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method for providing a first level of ad targeting and a second level of ad targeting, the method comprising:
determining, by a computing device, advertisement (ad) impressions previously determined for a site and respective predicted probabilities determined for the ad impressions, wherein a predicted probability is a probability that an ad impression belongs to a segment that is being targeted;
generating, by the computing device, a mapping table mapping predicted probabilities to respective precisions using seed data associated with the ad impressions, the seed data including features for users associated with the ad impressions;
generating, by the computing device, optimal options for using the first level and the second level for the segment using the mapping table, the optimal options including a first precision for the first level that is greater than a second precision for the second level and a ratio of ad inventories allocated to the first level and the second level; and
selecting, by the computing device, one of the optimal options, wherein the selected one of the optimal options comprise parameters including a first threshold for the first level, a second threshold for the second level, and the ratio that are used to test whether a predicted probability for an ad impression is targeted to the first level or the second level.

2. The method of claim 1, wherein the first level and the second level share ad inventory available for ad impressions based on the ratio.

3. The method of claim 2, wherein:
a maximum amount of ad inventory is available for the first level,
a first amount of ad inventory less than the maximum amount of ad inventory is allotted to the first level, and
a second amount of ad inventory from the maximum amount of ad inventory is allotted to the second level, and
a third amount of ad inventory is allotted to the second level.

4. The method of claim 3, wherein:
the maximum amount of ad inventory has a predicted probability above the first threshold for the first level,
the first amount of ad inventory has a predicted probability above the first threshold for the first level,
a second amount of ad inventory has a predicted probability above the first threshold for the second level, and
a third amount of ad inventory has a predicted probability above the second threshold for the second level, but below the first threshold for the second level.

5. The method of claim 1, wherein the optimal options are generated for all combinations of the first level and the second level available based on a set of restrictions for the first level and the second level including a restriction that the first precision for the first level is greater than the second precision for the second level.

6. The method of claim 5, wherein the set of restrictions comprise a restriction that a first minimum ad inventory for the first level and a second minimum ad inventory for the second level.

7. The method of claim 5, wherein the set of restrictions comprise a restriction that the second precision is higher than a minimum value.

8. The method of claim 1, further comprising:
receiving an ad impression;
predicting a probability that the ad impression belongs to the segment; and
determining whether the predicted probability applies to the first level or the second level based on comparing the predicted probability to the first threshold or the second threshold, and the ratio.

9. The method of claim 8, further comprising:
applying the ad impression to the first level in accordance with the ratio if the predicted probability is above the first level;
applying the ad impression to the second level if the predicted probability is above the first level in accordance with the ratio; and
applying the ad impression to the second level if the predicted probability is above the second level, but below the first level.

10. The method of claim 9, wherein applying the ad impression to the first level comprises:
comparing the ratio to a random number;
applying the ad impression to the first level if the comparison indicates the ad impression should be applied to the first level; and
applying the ad impression to the second level if the comparison indicates the ad impression should be applied to the second level.

11. The method of claim 1, further comprising refining the mapping table using third party data different from the ad impressions determined for the site.

12. A non-transitory computer-readable storage medium containing instructions for providing a first level of ad targeting and a second level of ad targeting, wherein the instructions, when executed, control a computer system to be configured for:
determining advertisement (ad) impressions previously determined for a site and respective predicted probabilities determined for the ad impressions, wherein a predicted probability is a probability that an ad impression belongs to a segment that is being targeted;
generating a mapping table mapping predicted probabilities to respective precisions using seed data associated with the ad impressions, the seed data including features for users associated with the ad impressions;
generating optimal options for using the first level and the second level for the segment using the mapping table, the optimal options including a first precision for the first level that is greater than a second precision for the second level and a ratio of ad inventories allocated to the first level and the second level; and
selecting one of the optimal options, wherein the selected one of the optimal options comprise parameters including a first threshold for the first level, a second threshold for the second level, and the ratio that are used to test whether a predicted probability for an ad impression is targeted to the first level or the second level.

13. The non-transitory computer-readable storage medium of claim 12, wherein the first level and the second level share ad inventory available for ad impressions based on the ratio.

14. The non-transitory computer-readable storage medium of claim 13, wherein:
a maximum amount of ad inventory is available for the first level,
a first amount of ad inventory less than the maximum amount of ad inventory is allotted to the first level, and
a second amount of ad inventory from the maximum amount of ad inventory is allotted to the second level, and
a third amount of ad inventory is allotted to the second level.

15. The non-transitory computer-readable storage medium of claim 14, wherein:
the maximum amount of ad inventory has a predicted probability above the first threshold for the first level,
the first amount of ad inventory has a predicted probability above the first threshold for the first level,
a second amount of ad inventory has a predicted probability above the first threshold for the second level, and
a third amount of ad inventory has a predicted probability above the second threshold for the second level, but below the first threshold for the second level.

16. The non-transitory computer-readable storage medium of claim 12, wherein the optimal options are generated for all combinations of the first level and the second level available based on a set of restrictions for the first level and the second level including a restriction that the first precision for the first level is greater than the second precision for the second level.

17. The non-transitory computer-readable storage medium of claim 16, wherein the set of restrictions comprise:
a restriction that a first minimum ad inventory for the first level and a second minimum ad inventory for the second level, and
a restriction that the second precision is higher than a minimum value.

18. The non-transitory computer-readable storage medium of claim 12, further configured for:
receiving an ad impression;
predicting a probability that the ad impression belongs to the segment; and
determining whether the predicted probability applies to the first level or the second level based on comparing the predicted probability to the first threshold or the second threshold, and the ratio.

19. The non-transitory computer-readable storage medium of claim 18, further configured for:
applying the ad impression to the first level in accordance with the ratio if the predicted probability is above the first level;
applying the ad impression to the second level if the predicted probability is above the first level in accordance with the ratio; and
applying the ad impression to the second level if the predicted probability is above the second level, but below the first level.

20. The non-transitory computer-readable storage medium of claim 19, wherein applying the ad impression to the first level comprises:
comparing the ratio to a random number;
applying the ad impression to the first level if the comparison indicates the ad impression should be applied to the first level; and
applying the ad impression to the second level if the comparison indicates the ad impression should be applied to the second level.

21. An apparatus comprising:
one or more computer processors; and
a non-transitory computer-readable storage medium comprising instructions, that when executed, control the one or more computer processors to be configured for:
determining advertisement (ad) impressions previously determined for a site and respective predicted probabilities determined for the ad impressions, wherein a predicted probability is a probability that an ad impression belongs to a segment that is being targeted;
generating a mapping table mapping predicted probabilities to respective precisions using seed data associated with the ad impressions, the seed data including features for users associated with the ad impressions;
generating optimal options for using the first level and the second level for the segment using the mapping table, the optimal options including a first precision for the first level that is greater than a second precision for the second level and a ratio of ad inventories allocated to the first level and the second level; and
selecting one of the optimal options, wherein the selected one of the optimal options comprise parameters including a first threshold for the first level, a second threshold for the second level, and the ratio that are used to test whether a predicted probability for an ad impression is targeted to the first level or the second level.
